(19) United States
(12) Patent Application Publication
(10) Pub. No.: US 2015/0133838 A1
(43) Pub. Date: May 14, 2015

(54) DEVICE FOR SCRATCHING THE BACK

(71) Applicant: Jedd Olsen, Draper, UT (US)

(72) Inventor: Jedd Olsen, Draper, UT (US)

(21) Appl. No.: 14/537,561

(22) Filed: Nov. 10, 2014

Related U.S. Application Data
(60) Provisional application No. 61/901,955, filed on Nov. 8, 2013.

(51) Int. Cl. A61H 99/00

(52) U.S. Cl. CPC A61H 99/00; A61H 2201/1657
USPC 601/137

(57) ABSTRACT

A device for scratching the back comprises a scratcher from which bands extend on opposite sides of the scratcher. The bands are of sufficient length to allow the user to grasp the bands in front of the user while the scratcher is positioned on the user's back. The user can pull on the bands to move the scratcher along the user's back. Because the bands are positioned in front of the user, it is therefore easier to pull on the bands to scratch the back than if the user had to reach overtop his shoulder as with prior art back scratchers.

### CROSS-REFERENCE TO RELATED APPLICATIONS

This application claims priority to U.S. Provisional Patent Application Ser. No. 61/901,955 (Attorney Docket No. 18531.16), filed Nov. 8, 2013, entitled “Device for Scratching the Back.”

### BACKGROUND

1. Field of the Invention

The present invention is directed to a device for scratching the back or other portion of the body.

2. Description of the Related Art

Many devices have been created for scratching the back. These devices generally comprise a rigid elongated structure. Such devices generally require the user to reach back over his shoulder while grasping the device to scratch his back. With these devices, it can often be difficult to target a particular area and to adequately scratch the area once found.

### BRIEF SUMMARY

The present invention extends to a device for scratching the back. The device comprises a scratcher from which bands extend on opposite sides of the scratcher. The bands are of sufficient length to allow the user to grasp the bands in front of the user while the scratcher is positioned on the user's back. The user can pull on the bands to move the scratcher along the user's back. Because the bands are positioned in front of the user, it is therefore easier to pull on the bands to scratch the back than if the user had to reach overtop his shoulder as with prior art back scratchers.

The scratcher can comprise a generally flat shape that includes protrusions on one or both sides. The protrusions can be pointed to enhance the scratching effect of the scratcher when moved. In some embodiments, the scratcher can be a generally rounded shape with pointed protrusions so that the scratcher resembles a cactus leaf. In some embodiments, the bands can include handles to facilitate the gripping and pulling of the bands.

In one embodiment, a device for scratching the back comprises a scratcher having a generally flat shape with protrusions on one or both sides; and a band that extends from opposite sides of the scratcher. The bands have a sufficient length to allow a user to grip opposite ends of the band in front of the user's body when the scratcher is positioned against the user's back.

In some embodiments, the protrusions of the scratcher are pointed.

In some embodiments, the band comprises a continuous loop with first and second portions of the loop extending from opposite sides of the scratcher.

In some embodiments, a third portion of the loop extends out from a third side of the scratcher to allow the length of the first and second portions of the loop to be shortened by pulling outwardly on the third portion.

In some embodiments, the third portion includes a clamp for securing the length of first and second portions.

In some embodiments, the device includes a handle contained on each of the first and second portions.

In some embodiments, the first and second portions each extend out from the scratcher through a pair of openings.

In some embodiments, the openings on each of the opposite sides are spaced apart to prevent the scratcher from twisting with respect to the band.

In some embodiments, the band comprises a strap.

In some embodiments, opposite ends of the strap comprise connectors for connecting the opposite ends together in front of the user while the scratcher is positioned against the user's back.

In some embodiments, the device comprises handles on opposite ends of the strap.

In some embodiments, the handles comprise balls.

In some embodiments, the protrusions on one side of the scratcher are more pointed than the protrusions on the other side of the scratcher.

In another embodiment, a device for scratching the back comprises a scratcher having a generally flat shape with protrusions on one or both sides, and finger holes positioned on an exterior surface of the scratcher that extend into the interior of the scratcher.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A and 1B illustrate an embodiment of a scratcher that includes bungee-like bands with handles;

FIGS. 2A and 2B illustrate an embodiment of a scratcher that includes bungee-like bands without handles;

FIGS. 3A and 3B illustrate an embodiment of a scratcher that includes strap-like bands without handles;

FIGS. 4A-4D illustrate an embodiment of a scratcher that includes strap-like bands with handles in the form of balls; and

FIG. 5 illustrates an embodiment of a scratcher that includes finger holes rather than bands into which a user can insert his fingers when using the scratcher.

### DETAILED DESCRIPTION

The present invention extends to a device for scratching the back. The device comprises a scratcher from which bands extend on opposite sides of the scratcher. The bands are of sufficient length to allow the user to grasp the bands in front of the user while the scratcher is positioned on the user's back. The user can pull on the bands to move the scratcher along the user's back. Because the bands are positioned in front of the user, it is therefore easier to pull on the bands to scratch the back than if the user had to reach overtop his shoulder as with prior art back scratchers.

The scratcher can comprise a generally flat shape that includes protrusions on one or both sides. The protrusions can be pointed to enhance the scratching effect of the scratcher when moved. In some embodiments, the scratcher can be a generally rounded shape with pointed protrusions so that the scratcher resembles a cactus leaf. In some embodiments, the bands can include handles to facilitate the gripping and pulling of the bands.

In one embodiment, a device for scratching the back comprises a scratcher having a generally flat shape with protrusions on one or both sides; and a band that extends from opposite sides of the scratcher. The bands have a sufficient length to allow a user to grip opposite ends of the band in front of the user's body when the scratcher is positioned against the user's back.

In some embodiments, the protrusions of the scratcher are pointed.

In some embodiments, the band comprises a continuous loop with first and second portions of the loop extending from opposite sides of the scratcher.

In some embodiments, a third portion of the loop extends out from a third side of the scratcher to allow the length of the first and second portions of the loop to be shortened by pulling outwardly on the third portion.

In some embodiments, the third portion includes a clamp for securing the length of first and second portions.

In some embodiments, the device includes a handle contained on each of the first and second portions.

In some embodiments, the first and second portions each extend out from the scratcher through a pair of openings.

In some embodiments, the openings on each of the opposite sides are spaced apart to prevent the scratcher from twisting with respect to the band.

In some embodiments, the band comprises a strap.

In some embodiments, opposite ends of the strap comprise connectors for connecting the opposite ends together in front of the user while the scratcher is positioned against the user's back.

In some embodiments, the device comprises handles on opposite ends of the strap.

In some embodiments, the handles comprise balls.

In some embodiments, the protrusions on one side of the scratcher are more pointed than the protrusions on the other side of the scratcher.

In another embodiment, a device for scratching the back comprises a scratcher having a generally flat shape with protrusions on one or both sides, and finger holes positioned on an exterior surface of the scratcher that extend into the interior of the scratcher.

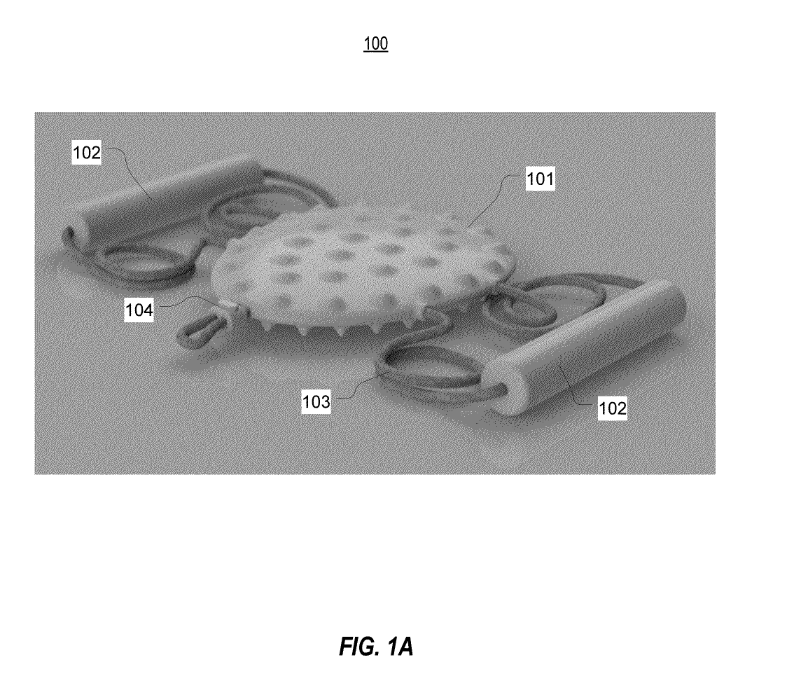

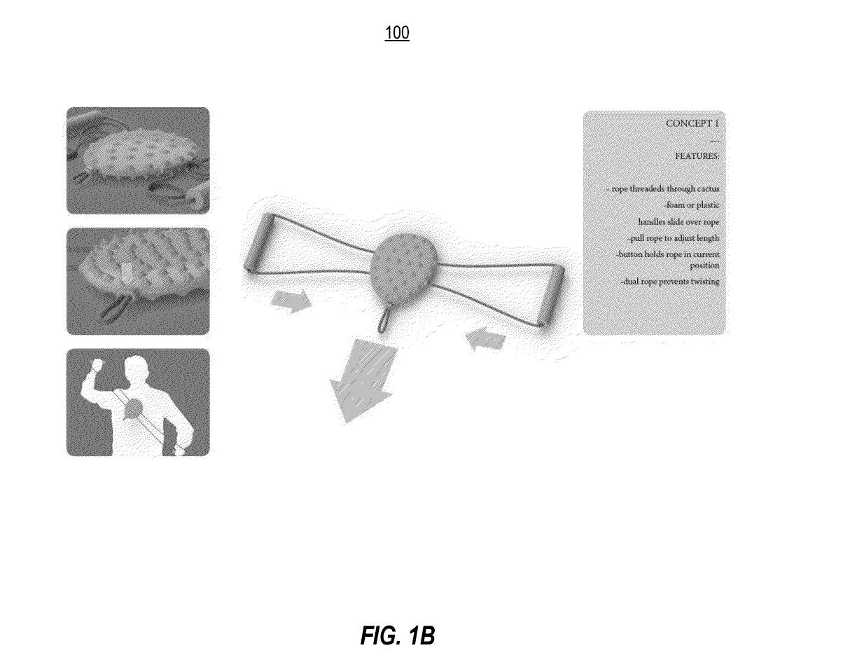

FIG. 1A illustrates a first embodiment of a device 100 for scratching the back. Device 100 comprises a scratcher 101 a continuous band 103 that extends through scratcher 101 and exits scratcher 101 on three sides, and handles 102 positioned overtop a first and a second portion of band 103 that extend from two of the sides. On the third side, a clamp 104 is positioned overtop a third portion of band 103 to secure the length of the first and second portions.

FIG. 1B illustrates how device 100 can be used to scratch the back of a user. The user can position scratcher 101 on his back while grasping handles 102 with each hand. Due to the length of band 103, the user can grip handles 102 while they are positioned in front of (or at least even with) the user's body. By pulling handles 102 back and forth, scratcher 101 is moved across the surface of the back to scratch it.

Band 103 can be configured as a single continuous band so that when the third portion of the band 103 that extends from the third side of scratcher 101 is pulled (i.e. the portion on which clamp 104 is positioned), the length of the first and second portions (i.e. those to which handles 102 are connected) will be shortened. In this way, handles 102 can be pulled in towards scratcher 101 to facilitate storage of device 100 or to shorten the length of device 100 for a particular use. Clamp 104 can clamp down onto band 103 to secure the length of the first and second portions of band 103.

To prevent scratcher 101 from twisting during use, the openings in scratcher 101 through which band 103 extend can be spaced. In this way, a wider pivot point is created to reduce the likelihood that scratcher 101 will twist with respect to band 103.

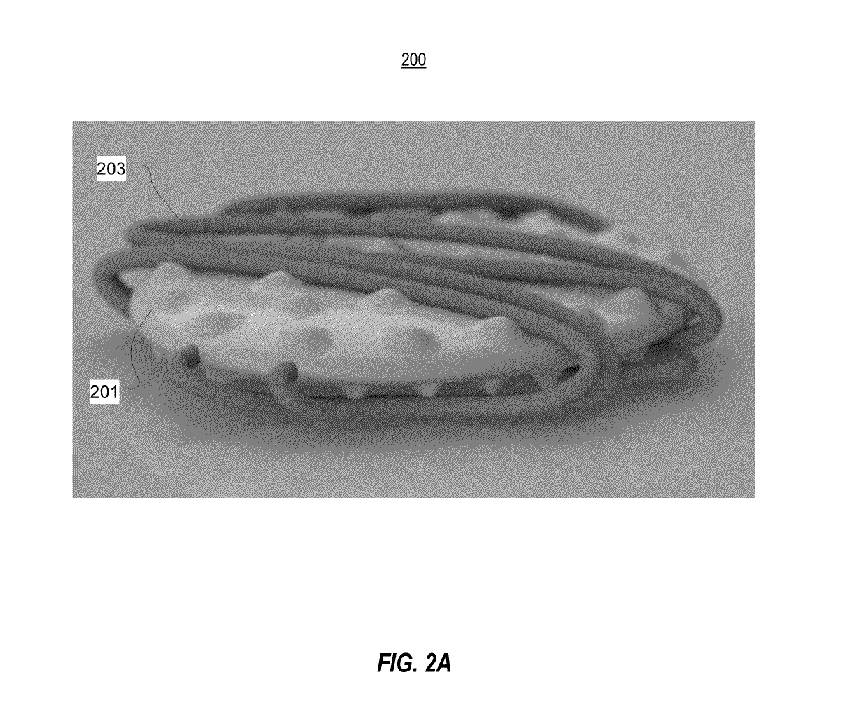

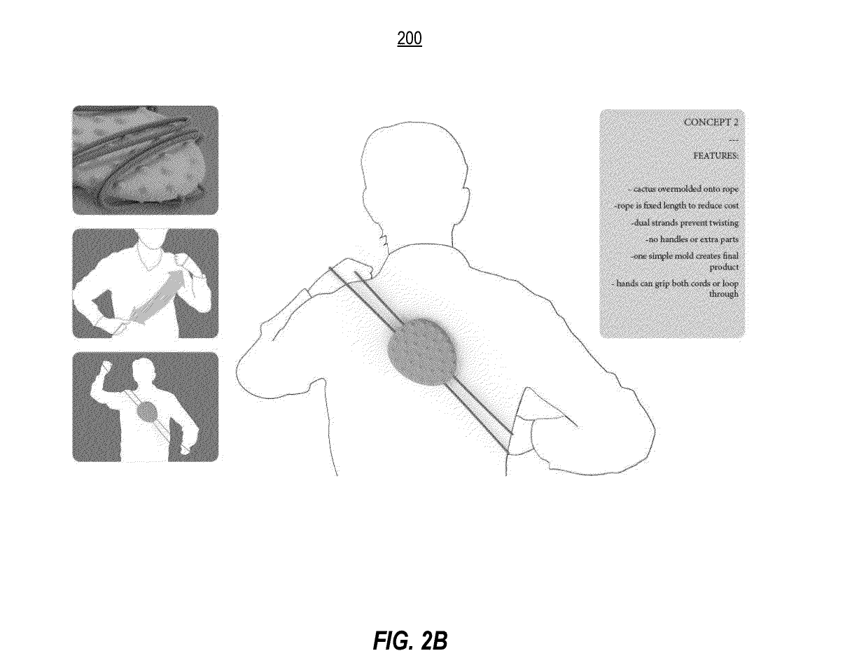

FIG. 2A illustrates a second embodiment of a device 200 for scratching the back. Device 200 includes a scratcher 201 and a band 203 that extends from opposite sides of scratcher 201. Device 200 is similar to device 100 except that, in device 200, band 203 is of a fixed length and does not include handles. In some embodiments, scratcher 201 can be molded over band 203. Therefore, band 203 may be comprised of a single loop of material that extends out from both sides, or of separate lengths of material on each side.

As shown in FIG. 2B, device 200 can also be used by gripping opposite ends of band 203 and pulling band 203 back and forth. Band 203 can have a sufficient length to allow the user to grasp both ends of band 203 in front of the user while scratcher 201 is positioned against the user's back.

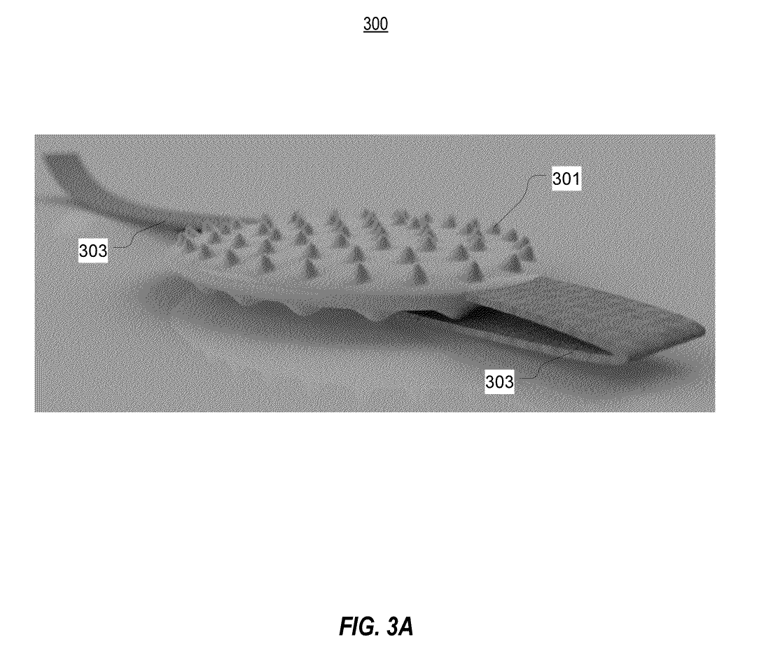

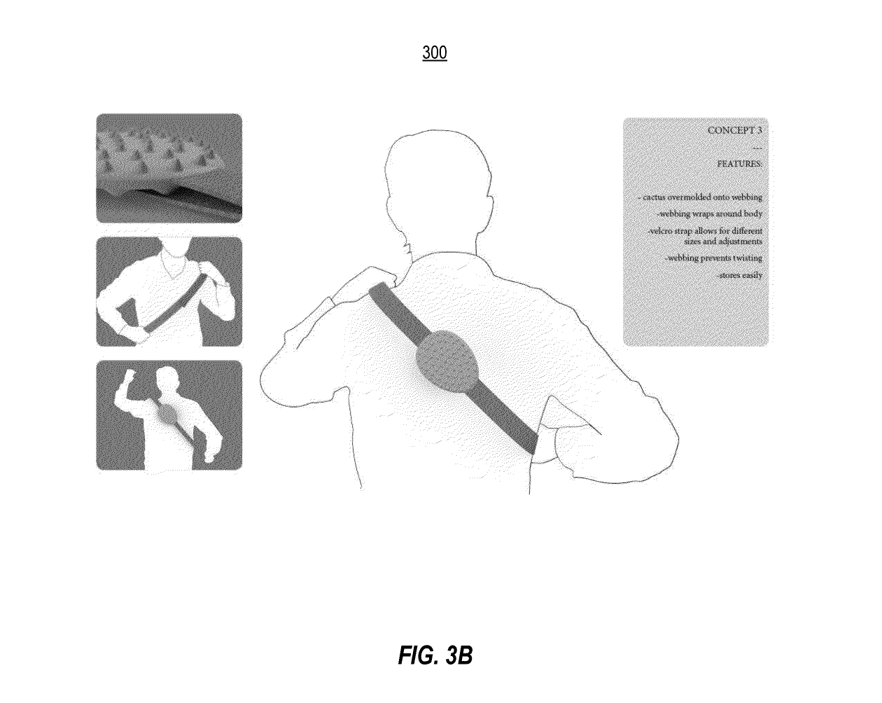

FIG. 3A illustrates a third embodiment of a device 300 for scratching the back. Device 300 includes a scratcher 301 and a band 303 that extends from opposite sides of scratcher. Band 303 is in the form of straps. In some embodiments, band 303 can be configured to allow the opposite sides of band 303 to attach such as by including hook and loop connectors on each side of band 303. Any other suitable connector for connecting the opposite ends of band 303 together could also be used. Also, band 303 can be formed of a single length or multiple lengths or material.

Because band 303 can include connectors, device 300 can be secured around the user's body. In this way, device 300 can be worn by the user even when not in use. When the opposite ends of band 303 are connected, the user can moved scratcher 301 by simply grasping any portion of band 303 and sliding the band back and forth. This can allow the user to scratch his back using a single hand.

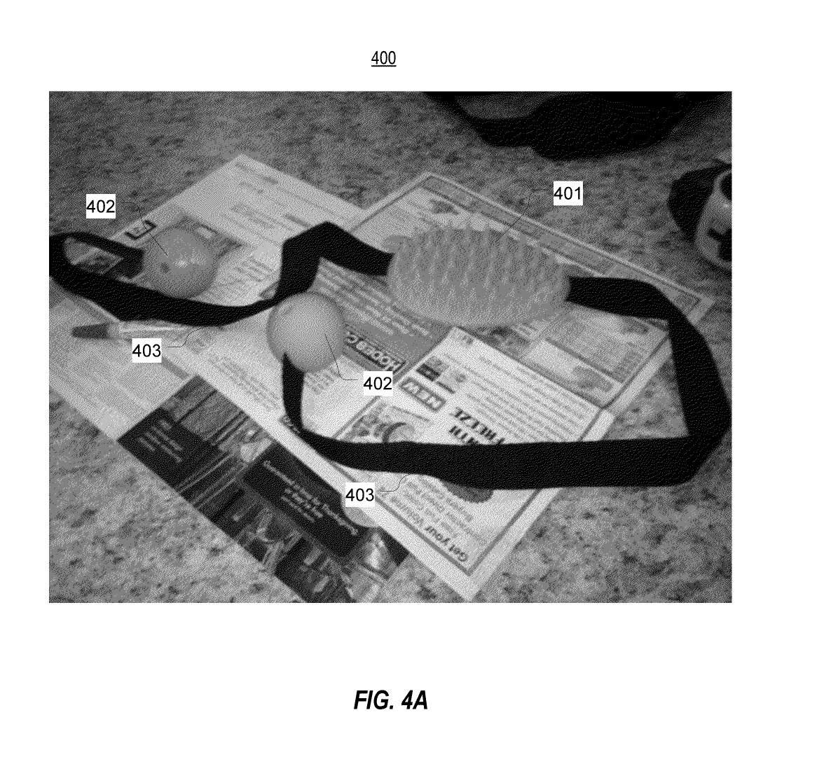

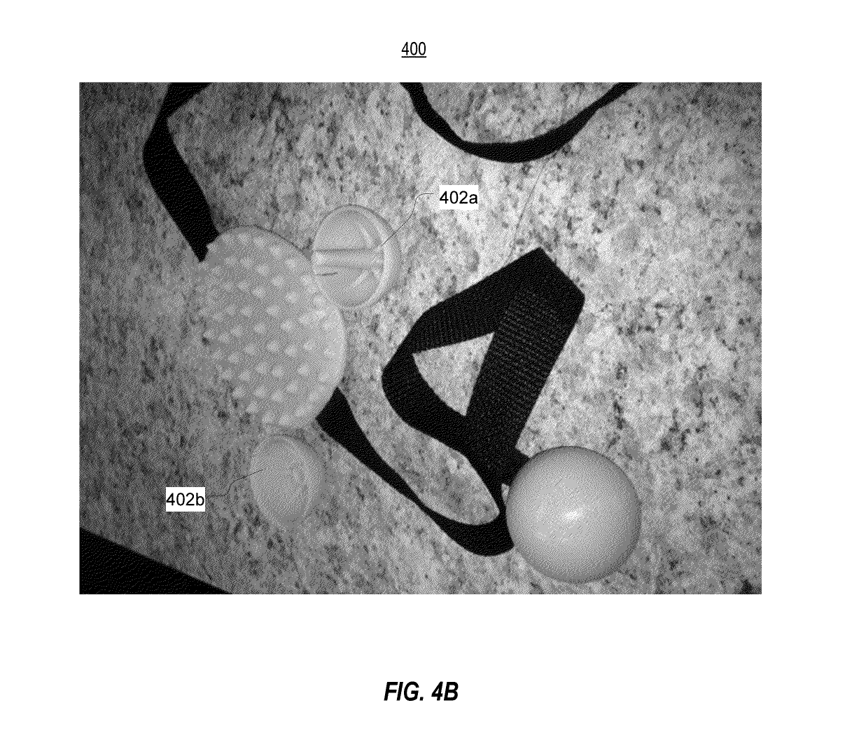

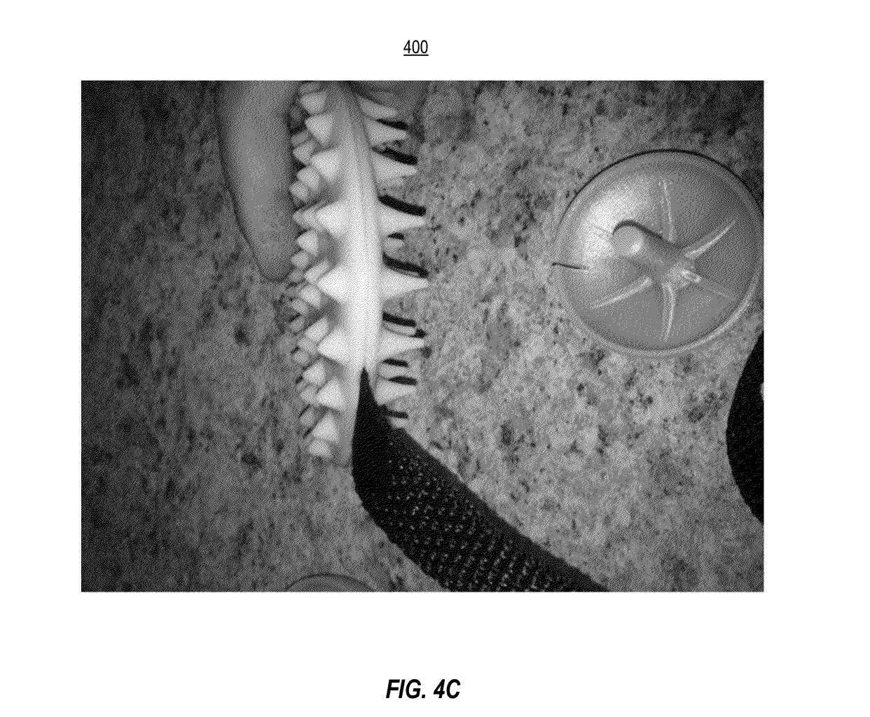

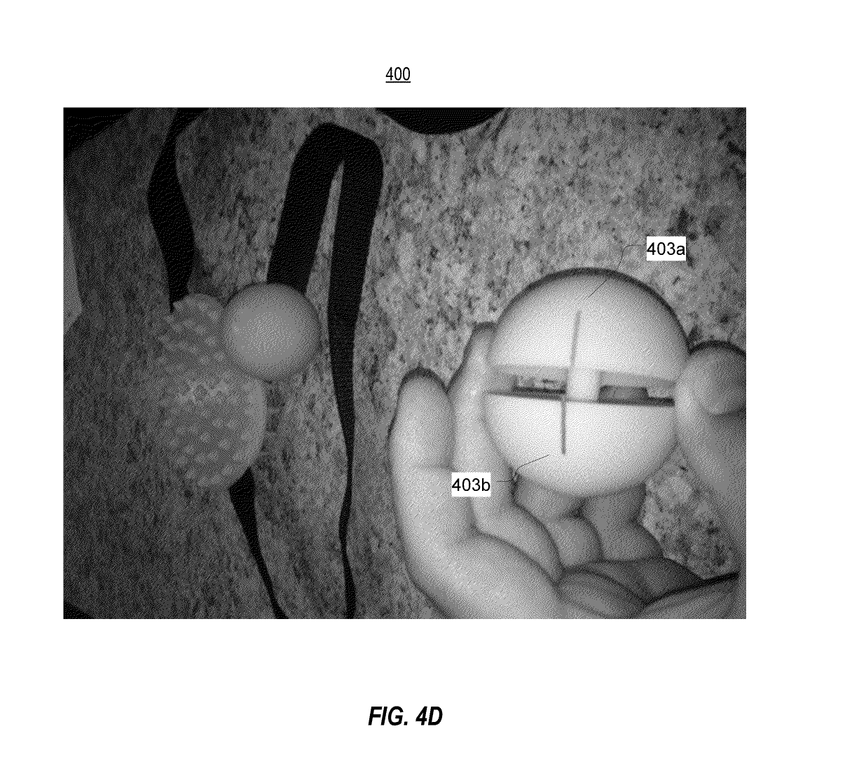

FIGS. 4A-4D illustrate a fourth embodiment of a device 400 for scratching the back. Device 400 includes a scratcher 401, band 403, and handles 402 on opposite ends of band 403. As shown, handles 402 can be in the form of balls although other shapes can also be used.

As shown in FIGS. 4B and 4D, each handle can be comprised of two components that are secured together overtop the ends of band 403. Each component can include a slit through which the band inserts. As shown in FIG. 4C, scratcher 401 can be comprised of two components that are secured together overtop band 403.

Device 400 can be used by positioning scratcher 401 against the user's back and pulling back and forth on handles 402 while handles 402 are positioned in front of the user's body.

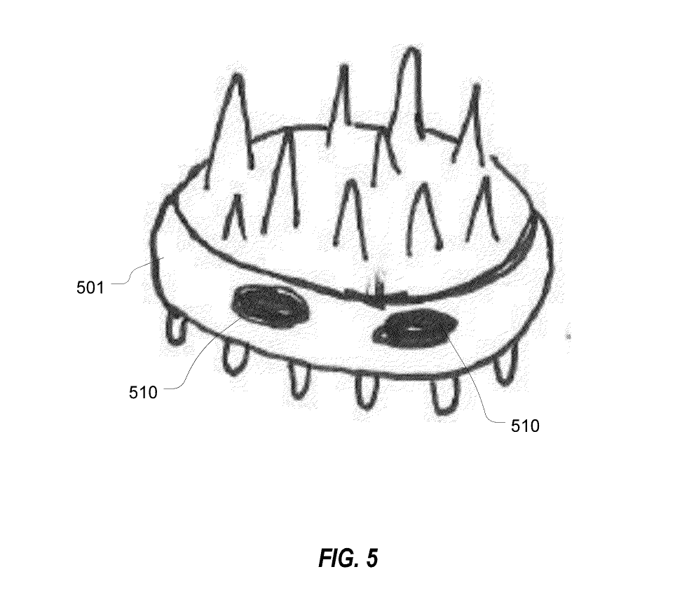

FIG. 5 illustrates an embodiment of a scratcher 501 that includes finger holes 510 to allow the scratcher to be worn on the fingers of a user. A user can insert his fingers into finger holes 510 and then use scratcher 501 to scratch any portion of his body or another person's body. Scratcher 501 can be configured to have a sufficient thickness to allow finger holes 510 to be formed on the side of scratcher 501 and extend into the interior of scratcher 501. Scratcher 501 can include protrusions on one or both sides which may be pointed to enhance the scratching effect of scratcher 501.

Although the above description discloses a device usable to scratch the back, these devices can also be used to scratch other portions of a person's body. For example, the scratcher can be positioned underneath the foot and moved back and forth by pulling on opposite ends of the band. Because the bands can extend a substantial distance from the scratcher, the device can facilitate scratching with minimal stretching, reaching, or bending of the body.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A device for scratching the back, comprising:
a scratcher having a generally flat shape with protrusions on one or both sides;
a band that extends from opposite sides of the scratcher, the bands having a sufficient length to allow a user to grip opposite ends of the band in front of the user's body when the scratcher is positioned against the user's back.

2. The device of claim 1, wherein the protrusions are pointed.

3. The device of claim 1, wherein the band comprises a continuous loop with first and second portions of the loop extending from opposite sides of the scratcher.

4. The device of claim 3, wherein a third portion of the loop extends out from a third side of the scratcher to allow the length of the first and second portions of the loop to be shortened by pulling outwardly on the third portion.

5. The device of claim 4, wherein the third portion includes a clamp for securing the length of first and second portions.

6. The device of claim 3, further comprising:
a handle contained on each of the first and second portions.

7. The device of claim 3, wherein the first and second portions each extend out from the scratcher through a pair of openings.

8. The device of claim 7, wherein the openings on each of the opposite sides are spaced apart to prevent the scratcher from twisting with respect to the band.

9. The device of claim 1, wherein the band comprises a strap.

10. The device of claim 9, wherein opposite ends of the strap comprise connectors for connecting the opposite ends together in front of the user while the scratcher is positioned against the user's back.

11. The device of claim 9, further comprising:
handles on opposite ends of the strap.

12. The device of claim 11, wherein the handles comprise balls.

13. The device of claim 1, wherein the protrusions on one side of the scratcher are more pointed than the protrusions on the other side of the scratcher.

14. A device for scratching the back, comprising:
a scratcher having a generally flat shape with protrusions on one or both sides;
finger holes positioned on an exterior surface of the scratcher that extend into the interior of the scratcher.
